(19) United States
(12) Patent Application Publication
(10) Pub. No.: US 2011/0265562 A1
(43) Pub. Date: Nov. 3, 2011

(54) NON-CONTACT LIQUID LEVEL SENSING SYSTEM FOR HOUSEHOLD ELECTRIC APPLIANCES

(76) Inventor: Wing Chung LI, Hong Kong (HK)

(21) Appl. No.: 12/770,761

(22) Filed: Apr. 30, 2010

(51) Int. Cl. G01F 23/26

(52) U.S. Cl. 73/304 C

(57) ABSTRACT

A non-contact liquid level sensing system for an electric appliance is provided. The electric appliance includes a liquid container for containing liquid. The non-contact liquid level sensing system includes a micro-controller and a plurality of sensors vertically aligned and mounted to the inside of the liquid container. The micron-controller includes a non-volatile memory for storing data. Each of the sensors includes a circuit board, a sensor pad made of a conductive material mounted on the circuit board, and a cover plate made of a dielectric material covering and being in direct contact with the sensor pad. The micro-controller is electrically connected with the sensors, and configured to measure the capacitance between the sensor pad of each sensor and a reference electric potential, and to determine a liquid level in the liquid tank based on the measured capacitance and the data stored in the non-volatile memory of the micro-controller.

### FIELD OF THE PATENT APPLICATION

The present application generally relates to household appliances, and more specifically, to a micro-controller based non-contact type liquid level sensing system for household electric appliances.

### BACKGROUND

Many household electric appliances such as water boilers, kettles, coffee makers, and etc. are equipped with a liquid tank for storing liquid such as water therein. For such household electric appliances it is often necessary to sense or measure the liquid level so as to determine how much liquid is contained. Conventional methods for liquid level sensing are mostly contact type methods, such as the multi-needle direct contact method, the contact resistance method, the pressure method and so on. In all these methods, a sensor unit has to be in direct contact with the liquid and as a result the accuracy of the measurement does not only depend on the liquid conductivity, purity, density and the ambient temperature, but also on the residual contamination or the residue of the liquid and the condition of the needle corrosion. Moreover, the direct contact between the sensor and the liquid may cause problems such as the isolation issue, which must be taken care of in the design and the manufacturing stage.

### SUMMARY

The present patent application is directed to a non-contact liquid level sensing system for an electric appliance. In one aspect, the electric appliance includes a liquid container for containing liquid. The non-contact liquid level sensing system includes a micro-controller and a plurality of sensors vertically aligned and mounted to the inside of the liquid container. The micron-controller includes a non-volatile memory for storing data. Each of the sensors includes a circuit board, a sensor pad made of a conductive material mounted on the circuit board, and a cover plate made of a dielectric material covering and being in direct contact with the sensor pad. The micro-controller is electrically connected with the sensors, and configured to measure the capacitance between the sensor pad of each sensor and a reference electric potential, and to determine a liquid level in the liquid tank based on the measured capacitance and the data stored in the non-volatile memory of the micro-controller.

The micro-controller may be configured to determine that the liquid level has reached the position of a sensor if the measured capacitance between the sensor pad of the sensor and the reference electric potential is greater than a predetermined value stored in the non-volatile memory of the micro-controller. The predetermined value may be based on the capacitance between the sensor pad of the sensor and the reference electric potential measured by the micro-controller when no liquid is covered on the sensor.

The reference electric potential may be a system ground potential for the non-contact liquid level sensing system.

The non-contact liquid level sensing system may further include a display. The micro-controller is electrically connected with the display and configured to display information regarding the determined liquid level on the display.

The micro-controller may be configured to control the operation of the electric appliance according to the determined liquid level. The sensor pad may be made of copper.

In another aspect, the electric appliance includes a liquid container for containing liquid and a display. The non-contact liquid level sensing system includes a micro-controller and a plurality of sensors vertically aligned and mounted to the inside of the liquid container. Each of the sensors includes a circuit board, a sensor pad made of a conductive material mounted on the circuit board, and a cover plate made of a dielectric material covering and being in direct contact with the sensor pad. The micro-controller is electrically connected with the sensors and the display, and configured to measure the capacitance between the sensor pad of each sensor and a reference electric potential, to thereby determine a liquid level in the liquid tank, and to display information regarding the determined liquid level on the display.

In yet another aspect, the electric appliance includes a liquid container for containing liquid. The non-contact liquid level sensing system includes a micro-controller and a plurality of sensors vertically aligned and mounted to the inside of the liquid container. Each of the sensors includes a circuit board, a sensor pad made of a conductive material mounted on the circuit board, and a cover plate made of a dielectric material covering and being in direct contact with the sensor pad. The micro-controller is electrically connected with the sensors, and configured to measure the capacitance between the sensor pad of each sensor and a reference electric potential, to thereby determine a liquid level in the liquid tank, and to control the operation of the electric appliance according to the determined liquid level.

The micro-controller may be configured to receive a command from a user from the control panel and control the operation of the electric appliance based on the determined liquid level and the user's command.

### BRIEF DESCRIPTION OF THE DRAWINGS

FIG. 1A is a perspective view of an electric kettle utilizing a non-contact liquid level sensing system according to an embodiment of the present patent application.

FIG. 1B is a perspective side view of the electric kettle depicted in FIG. 1A.

FIG. 1C is a perspective transparent view of the electric kettle depicted in FIG. 1A.

FIG. 2 is a partial view of a control panel of the electric kettle depicted in FIG. 1A.

FIG. 3 is a functional block diagram of the non-contact liquid level sensing system in the electric kettle depicted in FIG. 1A.

FIG. 4 is a circuit schematic diagram of the non-contact liquid level sensing system depicted in FIG. 3.

FIG. 5 illustrates the structure of a capacitive sensor in the non-contact liquid level sensing system depicted in FIG. 3 when no liquid is covered thereon.

FIG. 6 illustrates the capacitive sensor depicted in FIG. 5 when a liquid is covered thereon.

### DETAILED DESCRIPTION

Reference will now be made in detail to a preferred embodiment of the non-contact liquid level sensing system for household electric appliances disclosed in the present patent application, examples of which are also provided in the following description. Exemplary embodiments of the non-contact liquid level sensing system disclosed in the present patent application are described in detail, although it will be apparent to those skilled in the relevant art that some features that are not particularly important to an understanding of the non-contact liquid level sensing system may not be shown for the sake of clarity.

Furthermore, it should be understood that the non-contact liquid level sensing system disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

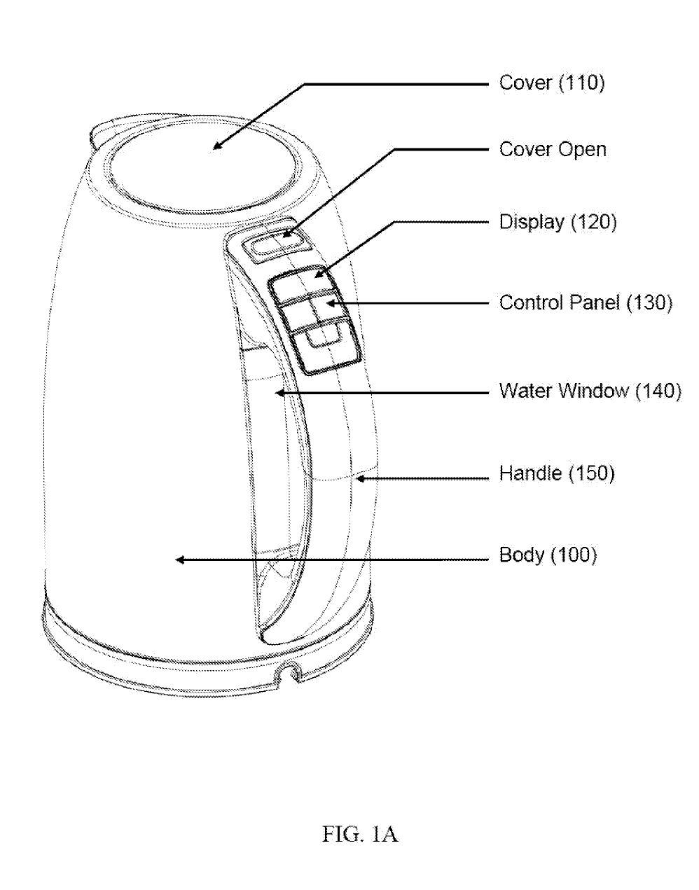

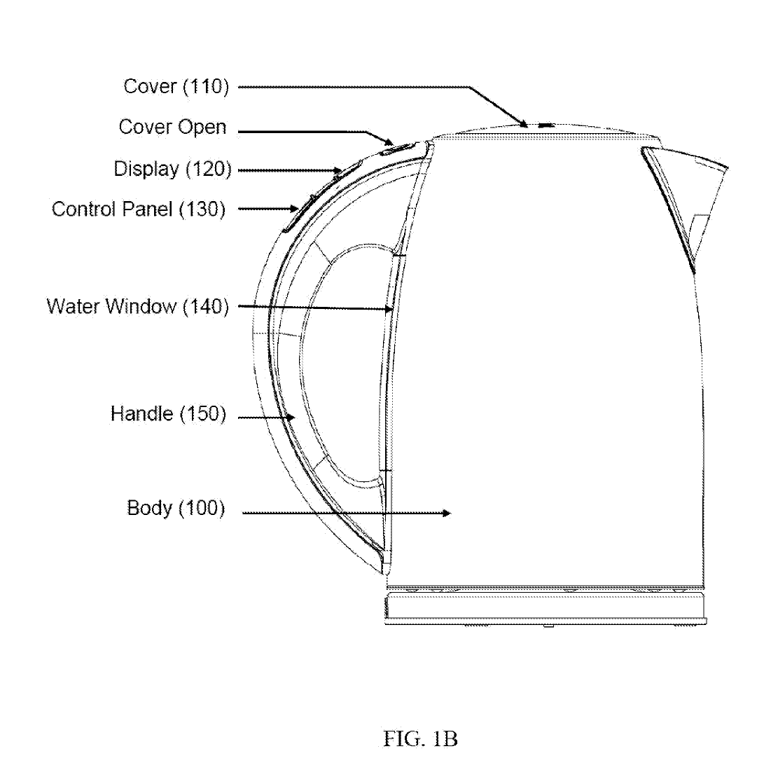

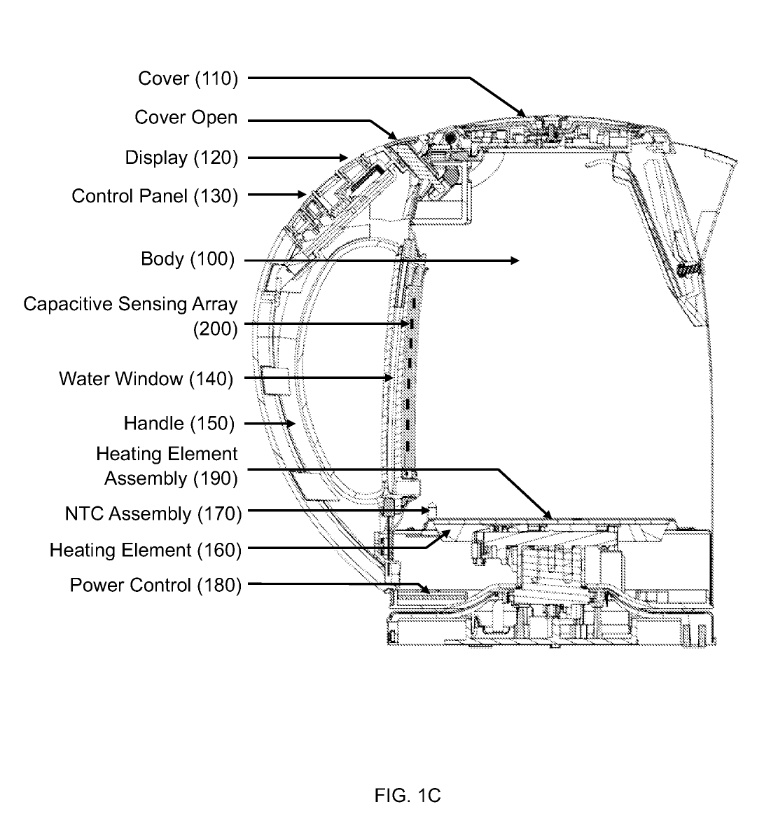

FIG. 1A is a perspective view of an electric kettle utilizing a non-contact liquid level sensing system according to an embodiment of the present patent application. FIG. 1B is a perspective side view of the electric kettle depicted in FIG. 1A. FIG. 1C is a perspective transparent view of the electric kettle depicted in FIG. 1A. Referring to FIGS. 1A-1C, the intelligent electronic kettle includes a heating element assembly 190 mounted under a water tank, a power supply and a heating power control PCBA (printed circuit board assembly) 180, a NTC (Negative Temperature Coefficient) assembly 170, a control panel 130, a display 120 and a capacitive sensing array 200. The heating element assembly 190 includes a heating element 160 and a heat conducting base which is a media for heat conduction from the heating element 160 to the bottom of the water tank. The display 120 includes a digital display (LCD or LED type) and a plurality of LED indicators. The digital display is configured to indicate the liquid level of the liquid in the water tank during the operation of the electric kettle. The capacitance sensing array 200 includes a plurality of independent capacitive sensors configured to sense the liquid level.

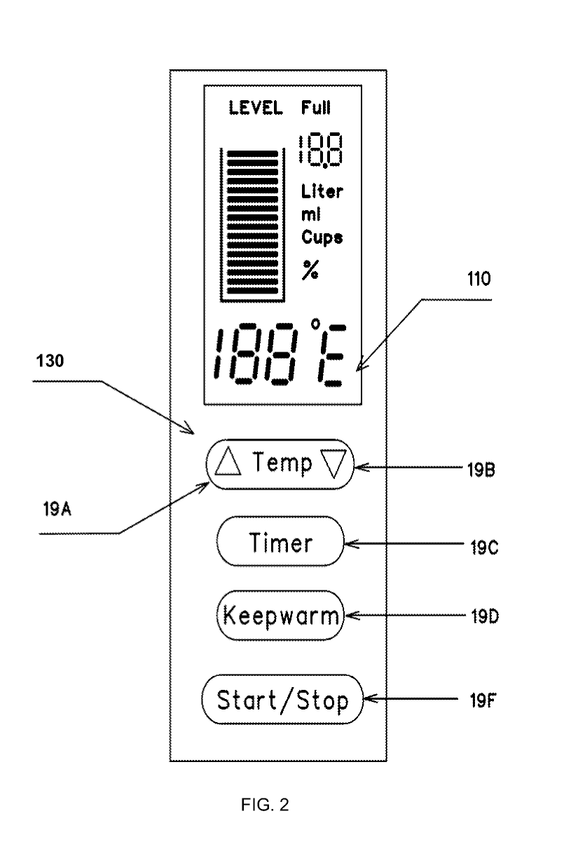

FIG. 2 is a partial view of the control panel 130 of the electric kettle depicted in FIG. 1A. Referring to FIG. 2, a digital display 110 is disposed on the control panel 130 and configured for displaying information regarding the liquid level of the liquid in the water tank and the temperature of the liquid.

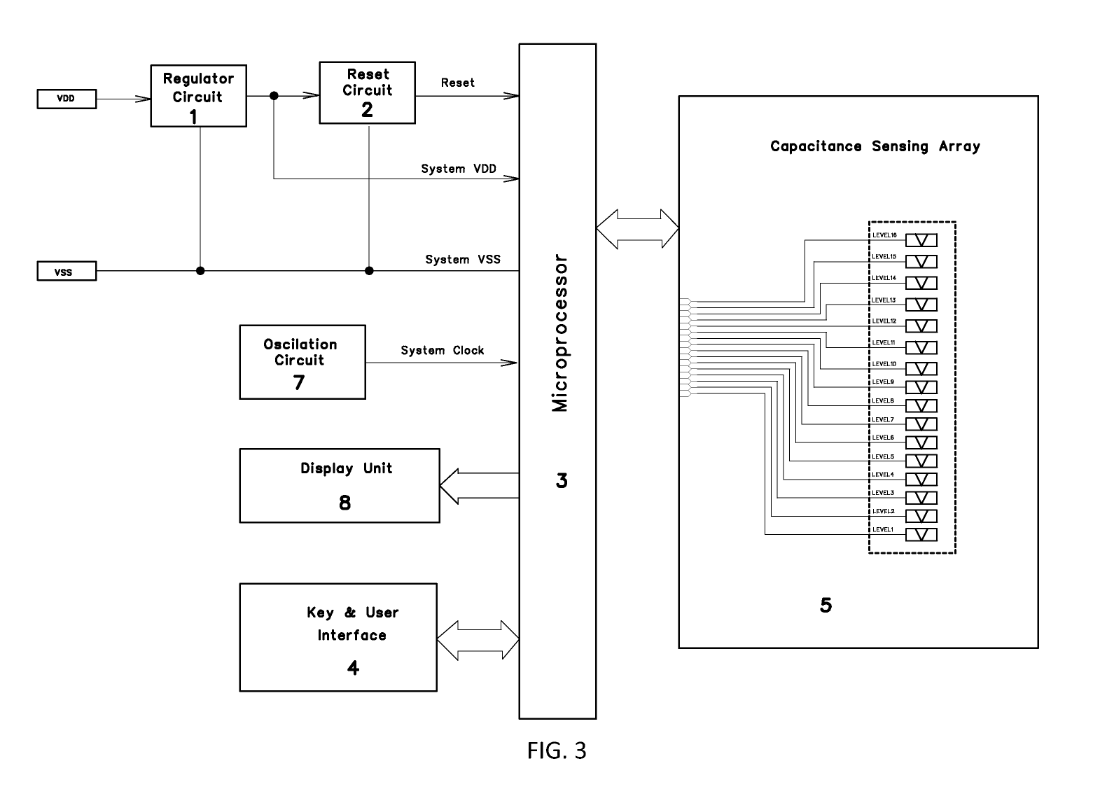

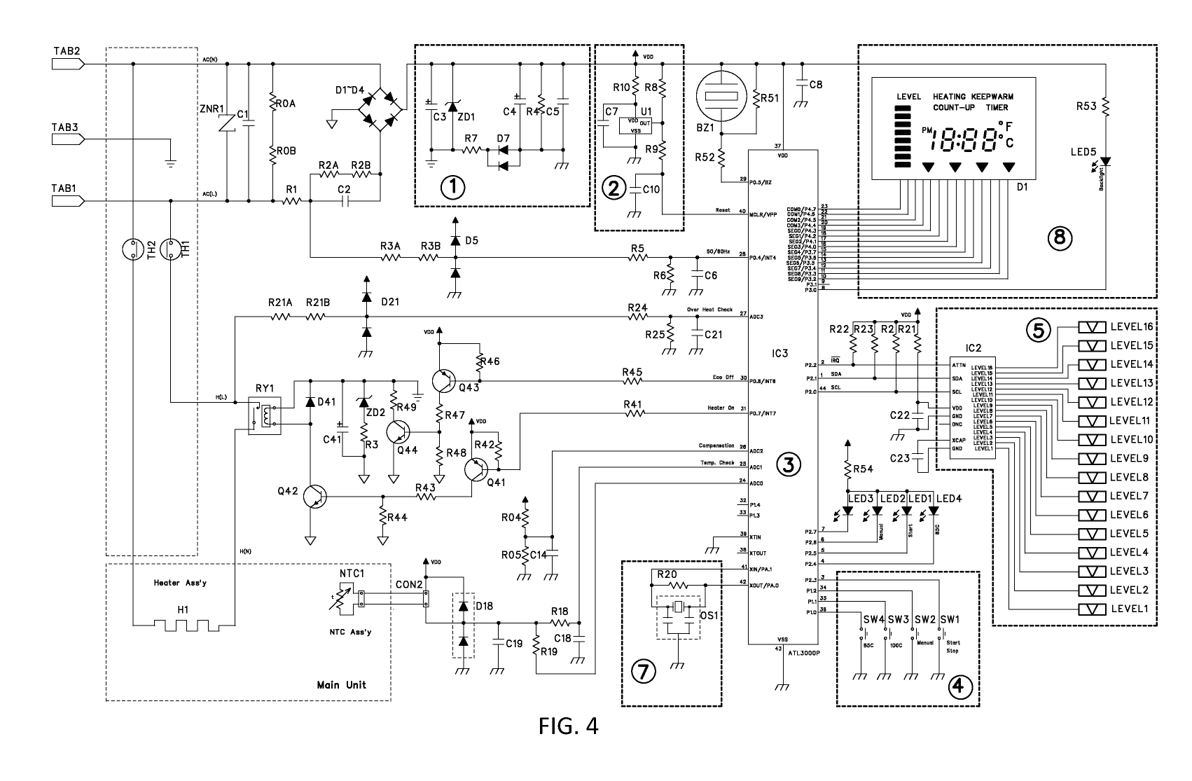

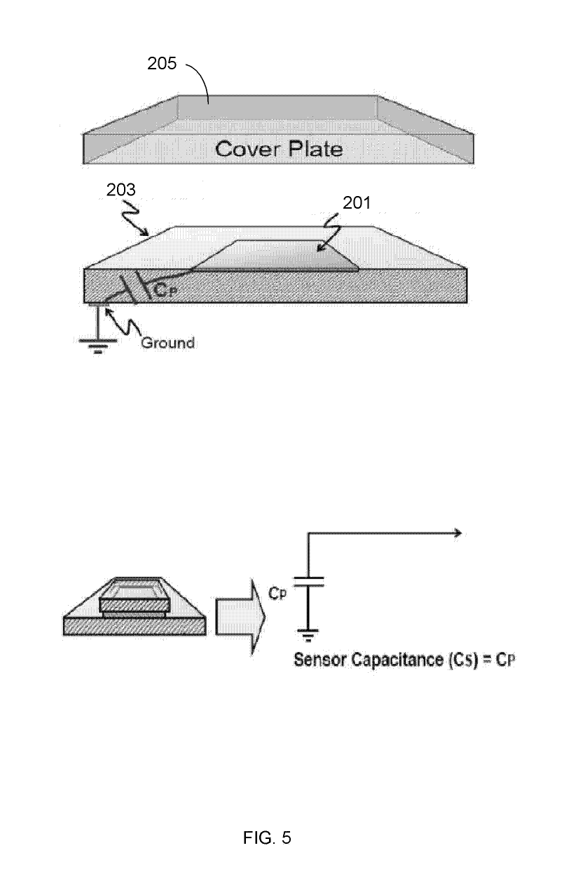

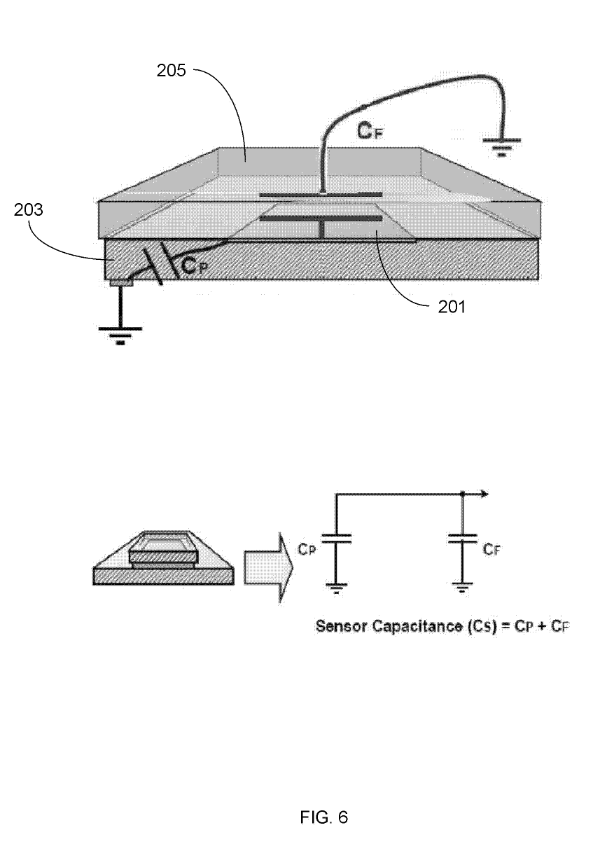

FIG. 3 is a functional block diagram of the non-contact liquid level sensing system in the electric kettle depicted in FIG. 1A. FIG. 4 is a circuit schematic diagram of the non-contact liquid level sensing system depicted in FIG. 3. Referring to FIG. 3 and FIG. 4, an incoming direct current (DC) is regulated by a regulator circuit 1 and provided to a micro-controller 3. The micro-controller 3 preferably incorporates a microprocessor, a programmable read-only memory (PROM) or erasable programmable read-only memory (EPROM) and a random access memory (RAM) as well as buffers and circuitry for the reception and manipulation of various inputs and outputs. The RAM is a volatile, or as known in the art, temporary shortage for data. Resetting the micro-controller or removing power supplied to the intelligent electronic kettle will erase the content of the RAM after a certain period of time. The microprocessor, the memory, the buffers and the circuitry are typically incorporated into a single integrated circuit or chip package, which is then referred to as the micro-controller. In the preferred embodiment, sets of instructions or programs are installed in the programmable memory. These instructions or programs will be discussed hereafter in more detail with references to FIGS. 5-6. The RAM is configured to temporarily store a plurality of parameters during the processing cycles.

Referring to FIG. 3 and FIG. 4, an oscillation circuit 7 is configured to provide high frequency clock pulses for the micro-controller 3 to synchronize the internal functions thereof. A keyboard 4 and a display portion 8 are incorporated into the control panel 130 (as illustrated in FIG. 2) to provide a user interface for the non contact liquid level sensing system. A sensor unit 5 is electrically connected with the micro-controller 3. The sensor unit 5 includes a plurality of capacitive sensors. The principle and the construction of each capacitive sensor are described hereafter in detail with references to FIG. 5 and FIG. 6.

FIG. 5 illustrates the structure of a capacitive sensor in the non-contact liquid level sensing system depicted in FIG. 3 when no liquid is covered thereon. Referring to FIG. 5, the capacitive sensor includes a sensor pad 201, a printed circuit board 203, and a cover plate 205. In this embodiment, the sensor pad 201 is made of copper. The sensor pad 201 is mounted on the printed circuit board 203 and has a fixed initial capacitance value C_{P} to a system ground through the printed circuit board 203. After the assembly is completed, the sensor pad 201 is tightly in direct contact with the cover plate 205. The cover plate 205 is made of a dielectric material and non-conductive, completely isolating the sensor pad 201 from the liquid. In this embodiment, a plurality of the above-mentioned capacitive sensors are vertically aligned and mounted to the inside of the water tank in an array, each of which corresponds to a different liquid level. As illustrated in FIG. 5, when the liquid level is lower than the cover plate 205, no liquid is covered on the cover plate 205 and thus the capacitance between the sensor pad 201 and the system ground is kept at C_{P}.

FIG. 6 illustrates the capacitive sensor depicted in FIG. 5 when a liquid is covered thereon. Referring to FIG. 6, when the liquid level reaches the cover plate 205, the liquid is covered on the cover plate 205. Since the liquid is typically conductive and connected to the system ground while the cover plate 205 is dielectric, a capacitance C_{F} between the sensor pad 201 beneath the cover plate 205 and the system ground is now introduced by the liquid. Thus the total capacitance between the sensor pad 201 and the system ground becomes C_{S}=C_{P}+C_{F}, which is different from C_{P} in the previous case when the liquid level is lower than the cover plate 205. The micro-controller 3 is configured to execute a program stored in the programmable memory thereof and detect such difference in the total capacitance and thereby determine whether the liquid level has reached the position of the capacitive sensor.

The above-mentioned detection may be realized by a comparison between the actually measured total capacitance and a predetermined value based on the capacitance C_{P} (the total capacitance for the case when no liquid is covered on the capacitive sensor). For example, the predetermined value based on the capacitance C_{P} may be pre-stored in the non-volatile programmable memory of the micro-controller 3, and if the measured total capacitance between the sensor pad of the sensor and the system ground is greater than the predetermined value, the micro-controller 3 is configured to determine that the liquid level has reached the position of the capacitive sensor. It is understood that in this embodiment, the system ground may be substituted by some other reference potential point.

In this embodiment, the micro-controller 3 is configured to display the liquid level information on the digital display 110 as illustrated in FIG. 2, and to control the operation of the electric kettle according to the liquid level, for example, to turn off the electric power supplied to the heating element 160 when the liquid level has reached a predetermined threshold. It is understood that a user may set up the predetermined threshold in the micro-controller through the control panel 130 so that the electric kettle operates according to the user's setup and the measured liquid level. It is further understood that the user may input a command through the control panel 130 to the micro-controller 3 and the micro-controller 3 may be configured to execute a program and control the operation of the electric kettle based on the user's command, the measured liquid level and other parameters.

While the present patent application has been shown and described with particular references to a number of embodiments thereof, it should be noted that various other changes or modifications may be made without departing from the scope of the present invention.

What is claimed is:

1. A non-contact liquid level sensing system for an electric appliance, the electric appliance comprising a liquid container for containing liquid, the non-contact liquid level sensing system comprising:
a micro-controller, the micron-controller comprising a non-volatile memory for storing data; and
a plurality of sensors vertically aligned and mounted to the inside of the liquid container, each of the sensors comprising:
a circuit board,
a sensor pad made of a conductive material mounted on the circuit board, and
a cover plate made of a dielectric material covering and being in direct contact with the sensor pad; wherein:
the micro-controller is electrically connected with the sensors, and configured to measure the capacitance between the sensor pad of each sensor and a reference electric potential, and to determine a liquid level in the liquid tank based on the measured capacitance and the data stored in the non-volatile memory of the micro-controller.

2. The non-contact liquid level sensing system of claim 1, wherein the micro-controller is configured to determine that the liquid level has reached the position of a sensor if the measured capacitance between the sensor pad of the sensor and the reference electric potential is greater than a predetermined value stored in the non-volatile memory of the micro-controller.

3. The non-contact liquid level sensing system of claim 2, wherein the predetermined value is based on the capacitance between the sensor pad of the sensor and the reference electric potential measured by the micro-controller when no liquid is covered on the sensor.

4. The non-contact liquid level sensing system of claim 1, wherein the reference electric potential is a system ground potential for the non-contact liquid level sensing system.

5. The non-contact liquid level sensing system of claim 1 further comprising a display, wherein the micro-controller is electrically connected with the display and configured to display information regarding the determined liquid level on the display.

6. The non-contact liquid level sensing system of claim 1, wherein the micro-controller is configured to control the operation of the electric appliance according to the determined liquid level.

7. The non-contact liquid level sensing system of claim 1, wherein the sensor pad is made of copper.

8. A non-contact liquid level sensing system for an electric appliance, the electric appliance comprising a liquid container for containing liquid and a display, the non-contact liquid level sensing system comprising:
a micro-controller; and
a plurality of sensors vertically aligned and mounted to the inside of the liquid container, each of the sensors comprising:
a circuit board,
a sensor pad made of a conductive material mounted on the circuit board, and
a cover plate made of a dielectric material covering and being in direct contact with the sensor pad; wherein:
the micro-controller is electrically connected with the sensors and the display, and configured to measure the capacitance between the sensor pad of each sensor and a reference electric potential, to thereby determine a liquid level in the liquid tank, and to display information regarding the determined liquid level on the display.

9. The non-contact liquid level sensing system of claim 8, wherein the micro-controller is configured to determine that the liquid level has reached the position of a sensor if the measured capacitance between the sensor pad of the sensor and the reference electric potential is greater than a predetermined value.

10. The non-contact liquid level sensing system of claim 9, wherein the predetermined value is based on the capacitance between the sensor pad of the sensor and the reference electric potential measured by the micro-controller when no liquid is covered on the sensor.

11. The non-contact liquid level sensing system of claim 8, wherein the reference electric potential is a system ground potential for the non-contact liquid level sensing system.

12. The non-contact liquid level sensing system of claim 8, wherein the micro-controller is configured to control the operation of the electric appliance according to the determined liquid level.

13. The non-contact liquid level sensing system of claim 8, wherein the sensor pad is made of copper.

14. A non-contact liquid level sensing system for an electric appliance, the electric appliance comprising a liquid container for containing liquid, the non-contact liquid level sensing system comprising:
a micro-controller; and
a plurality of sensors vertically aligned and mounted to the inside of the liquid container, each of the sensors comprising:
a circuit board,
a sensor pad made of a conductive material mounted on the circuit board, and
a cover plate made of a dielectric material covering and being in direct contact with the sensor pad; wherein:
the micro-controller is electrically connected with the sensors, and configured to measure the capacitance between the sensor pad of each sensor and a reference electric potential, to thereby determine a liquid level in the liquid tank, and to control the operation of the electric appliance according to the determined liquid level.

15. The non-contact liquid level sensing system of claim 14, wherein the micro-controller is configured to determine that the liquid level has reached the position of a sensor if the measured capacitance between the sensor pad of the sensor and the reference electric potential is greater than a predetermined value.

16. The non-contact liquid level sensing system of claim 15, wherein the predetermined value is based on the capacitance between the sensor pad of the sensor and the reference electric potential measured by the micro-controller when no liquid is covered on the sensor.

17. The non-contact liquid level sensing system of claim 16, wherein the micron-controller comprises a non-volatile memory and the predetermined value is stored in the non-volatile memory of the micro-controller.

18. The non-contact liquid level sensing system of claim 14, wherein the reference electric potential is a system ground potential for the non-contact liquid level sensing system.

19. The non-contact liquid level sensing system of claim 14, wherein the sensor pad is made of copper.

20. The non-contact liquid level sensing system of claim 14 further comprising a control panel, wherein the micro-controller is configured to receive a command from a user from the control panel and control the operation of the electric appliance based on the determined liquid level and the user's command.
